(19) United States
(12) Patent Application Publication
(10) Pub. No.: US 2016/0202722 A1
(43) Pub. Date: Jul. 14, 2016

(54) TRANSMISSION DEVICE AND METHOD FOR CONTROLLING FIFO CIRCUIT

(71) Applicant: Fujitsu Optical Components Limited, Kawasaki-shi (JP)

(72) Inventor: Naoki Kuwata, Yokohama (JP)

(73) Assignee: Fujitsu Optical Components Limited, Kawasaki (JP)

(21) Appl. No.: 14/943,492

(22) Filed: Nov. 17, 2015

(30) Foreign Application Priority Data
Jan. 13, 2015 (JP) 2015-004530

(51) Int. Cl. G06F 1/08

(52) U.S. Cl. CPC G06F 1/08

(57) ABSTRACT

A transmission device includes: a write pointer controller that generates a write pointer by using a write clock recovered from a data signal; a read clock generator that generates a read clock; a read pointer controller that generates a read pointer by using the read clock; a memory in which the data signal is written to a bit specified by the write pointer, and the data signal is read from a bit specified by the read pointer; a detector that detects a usage rate of the memory according to a difference between the write pointer and the read pointer and; a frequency controller that generates a frequency control signal that changes a frequency of the read clock when the usage rate is out of a specified allowable range. The read clock generator controls the frequency of the read clock according to the frequency control signal.

### CROSS-REFERENCE TO RELATED APPLICATION

This application is based upon and claims the benefit of priority of the prior Japanese Patent Application No. 2015-004530, filed on Jan. 13, 2015, the entire contents of which are incorporated herein by reference.

### FIELD

The embodiments discussed herein are related to a transmission device and a method for controlling a FIFO (First-in First-out) circuit used in the transmission device.

### BACKGROUND

As a result of improvements in optical transmission technology, the speeding-up of networks has been realized. However, there is a limit to the amount an electrical signal can be sped up. Therefore, a configuration in which a plurality of electrical signals are processed in parallel is employed in a circuit within a transmission device (for example, a transceiver module).

When a plurality of data signals are processed in parallel in an electrical domain, it is preferable that the plurality of data signals be synchronized with each other. When the synchronization of a plurality of data signals is established, timings of the plurality of data signals are controlled by using, for example, a FIFO (First-in First-out) circuit provided for each data channel.

In the FIFO circuit, an input data signal is written to a memory in accordance with a write clock. The write clock is recovered, for example, from the input data signal. An example of the memory is a ring buffer. The data signal written to the memory is read in accordance with a read clock. A frequency of the write clock is substantially the same as a frequency of the read clock.

When a plurality of data signals are processed in parallel, a FIFO circuit is provided for each of the plurality of data signals. Data signals are read from a plurality of FIFO circuits by using a common read clock so as to establish the synchronization of the plurality of data signals.

However, a frequency of a write clock and a frequency of a read clock may fail to completely coincide with each other. When the two frequencies do not coincide with each other, a signal error may occur. As an example, when the frequency of the read clock is higher than the frequency of the write clock, a buffer becomes “empty”, and a signal error whereby a data signal fails to be output may occur. When the frequency of the read clock is lower than the frequency of the write clock, the buffer becomes “full”, and a signal error whereby a data signal is discarded may occur.

Therefore, a method for detecting “full (overflow)” and “empty (underflow)” of a ring buffer is proposed (for example, Japanese Laid-open Patent Publication No. 2010-160653 and Japanese Laid-open Patent Publication No. 2005-148904). In addition, Japanese Laid-open Patent Publication No. 2000-165362 (Japanese Patent No. 3488907) describes a related technology.

As described above, in a configuration in which the synchronization of data signals is established by using FIFO circuits, each of the data signals is written to a memory of a corresponding FIFO circuit in accordance with a write clock. However, when a phase of the write clock is shifted, a frequency of the write clock is substantially changed, and therefore a margin against a signal error is reduced. Stated another way, when the phase of the write clock is shifted, a signal error may occur.

This problem can be solved, for example, by increasing a memory size of a FIFO circuit. However, when the memory size is increased, a cost for the FIFO circuit (and a transceiver module equipped with the FIFO circuit) is increased, and this solution is not preferable.

### SUMMARY

According to an aspect of the embodiments, a transmission device includes: a write pointer controller that generates a write pointer by using a write clock recovered from a data signal; a read clock generator that generates a read clock; a read pointer controller that generates a read pointer by using the read clock; a memory in which the data signal is written to a bit specified by the write pointer, and the data signal is read from a bit specified by the read pointer; a detector that detects a usage rate of the memory according to a difference between the write pointer and the read pointer and; a frequency controller that generates a frequency control signal that changes a frequency of the read clock when the usage rate is out of a specified allowable range. The read clock generator controls the frequency of the read clock according to the frequency control signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a network system.

FIG. 2 illustrates an example of a FIFO circuit according to the first embodiment.

FIGS. 3A and 3B are diagrams explaining an allowable range of a usage rate.

FIG. 4 illustrates an example of an operation of a PLL circuit.

FIG. 5 is a flowchart illustrating a method for controlling a FIFO circuit according to the first embodiment.

FIG. 6 is a time chart illustrating an operation when it is determined that a ring buffer may become “full”.

FIG. 7 is a time chart illustrating an operation when it is determined that a ring buffer may become “empty”.

FIG. 8 illustrates an example of an operation of a FIFO circuit according to the first embodiment.

FIG. 9 illustrates an example of an effect according to the first embodiment.

FIG. 10 illustrates an example of a FIFO circuit according to the second embodiment.

FIG. 11 is a flowchart illustrating a method for controlling a FIFO circuit according to the second embodiment.

FIG. 12 illustrates an example of an operation of a FIFO circuit according to the second embodiment.

FIG. 13 illustrates an example of a configuration of a transmission device using a synchronizing circuit.

FIG. 14 illustrates an example of a FIFO circuit according to the third embodiment.

FIG. 15 is a flowchart illustrating a method for controlling a FIFO circuit according to the third embodiment.

FIGS. 16A and 16B illustrate an example of an effect according to the third embodiment.

### DESCRIPTION OF EMBODIMENTS

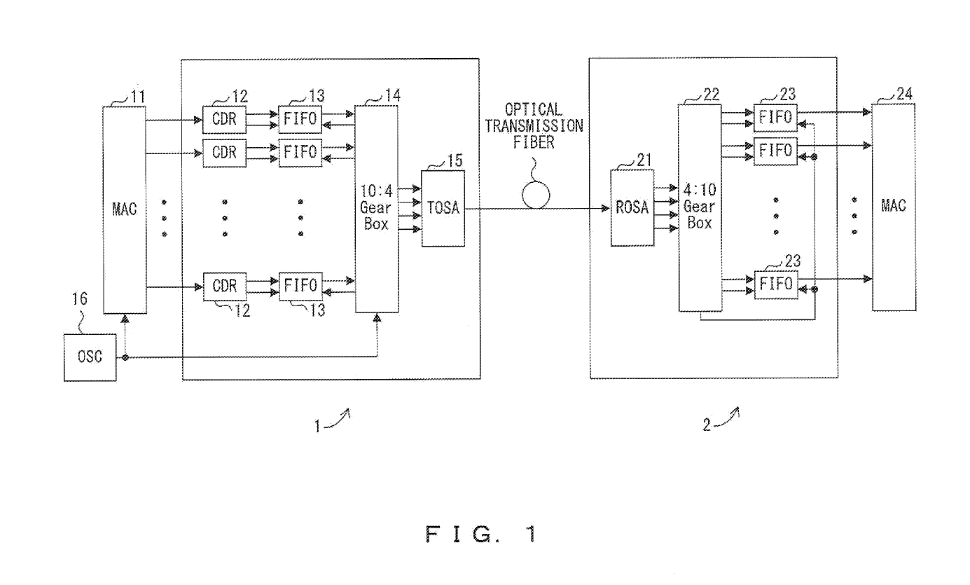

FIG. 1 illustrates an example of a network system using a transmission device according to one embodiment. In the network system illustrated in FIG. 1, a signal of 100 Gbps is transmitted from a transmission device 1 to a transmission device 2. The 100-Gbps transmission is realized by a WDM (Wavelength Division Multiplexing) of 25 Gbps×4 ch in this example.

The transmission device 1 includes a MAC circuit 11, a plurality of CDRs (Clock Data Recoveries) 12, a plurality of FIFO (First-in First-out) circuits 13, a gearbox 14, a TOSA (Transmitter Optical Sub-Assembly) 15, and an oscillator 16. The MAC circuit 11 outputs a signal of 10 Gbps×10 ch. The CDR 12 recovers a data signal and a clock from a corresponding input signal. The FIFO circuit 13 includes a buffer memory. To the buffer memory, a data signal is written in accordance with a clock recovered by the CDR 12. Data signals are read from the plurality of FIFO circuits 13 by using a common read clock. In this configuration, the synchronization of the plurality of data signals is established.

The gearbox 14 converts ten data signals into four data signals. Namely, four 25-Gbps data signals are generated. The MAC circuit 11 and the gearbox 14 operate according to a clock generated by the oscillator 16. The TOSA 15 respectively converts the four data signals into optical data signals. The TOSA 15 then multiplexes the four optical data signals so as to generate a WDM optical signal. The WDM optical signal transmitted from the transmission device 1 is received by the transmission device 2.

The transmission device 2 includes a ROSA (Receiver Optical Sub-Assembly) 21, a gearbox 22, a plurality of FIFO circuits 23, and a MAC circuit 24. The ROSA 21 separates the WDM optical signal transmitted from the transmission device 1 for each wavelength so as to recover four data signals. The gearbox 22 converts the four data signals into ten data signals. Namely, ten 10-Gbps data signals are recovered. Then, the MAC circuit 24 processes the recovered data signals.

### First Embodiment

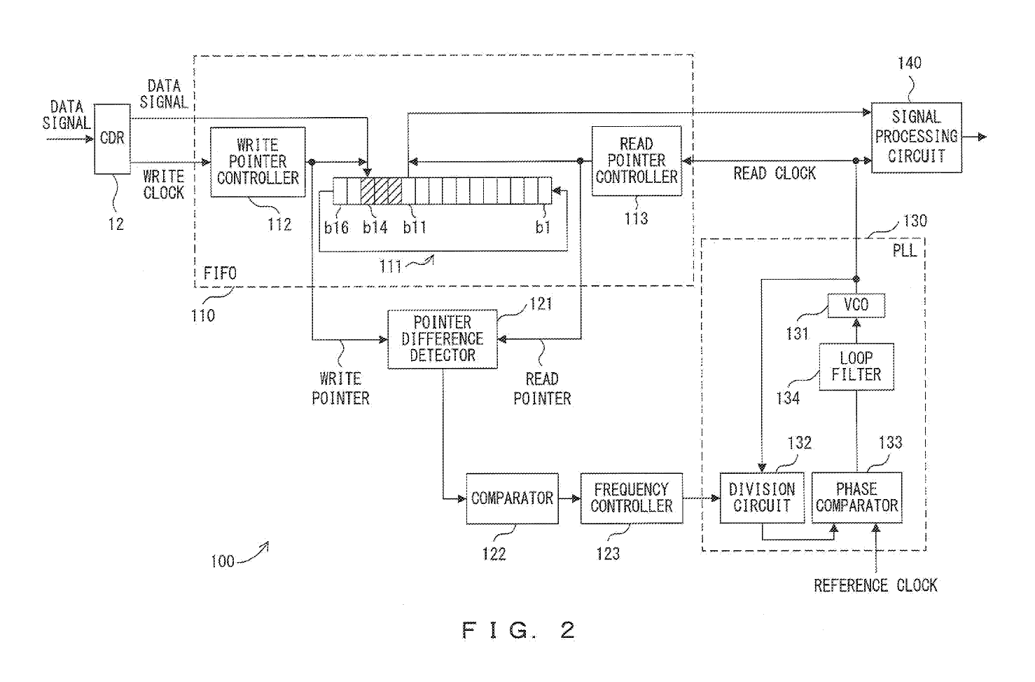

FIG. 2 illustrates an example of a FIFO circuit according to the first embodiment. A FIFO circuit 100 according to the first embodiment includes a FIFO memory 110, a pointer difference detector 121, a comparator 122, a frequency controller 123, and a PLL circuit 130. The FIFO circuit 100 illustrated in FIG. 2 corresponds, for example, to the FIFO circuit 13 implemented in the transmission device 1 illustrated in FIG. 1. Therefore, in this example, a data signal and a clock signal that are recovered by the CDR 12 are input to the FIFO circuit 100. A clock recovered by the CDR 12 is used to write a data signal to a memory in the FIFO circuit 100. Therefore, in the description below, the clock recovered by the CDR 12 may be referred to as a “write clock”.

As described above, the FIFO circuit 100 is used, for example, in a transmission circuit of a transmission device. However, the FIFO circuit 100 may be used in a receiver circuit of a transmission device. As an example, the FIFO circuit 100 may be used for the FIFO circuit 23 implemented in the transmission device 2 illustrated in FIG. 1.

The FIFO memory 110 includes a ring buffer 111, a write pointer controller 112, and a read pointer controller 113. The ring buffer 111 temporarily stores data signals. In this example, the ring buffer 111 can store data of 16 bits. Namely, the ring buffer 111 includes memory elements b1-b16.

The write pointer controller 112 generates a write pointer by using a write clock. The write pointer is incremented by one by the write clock. However, the write pointer cyclically counts the write clock according to the number of memory elements of the ring buffer 111. Namely, in this example, the write pointer cyclically counts “1” to “16” according to the write clock.

The read pointer controller 113 generates a read pointer by using a read clock. The read pointer is incremented by one by the read clock. The read pointer cyclically counts the read clock according to the number of memory elements. Namely, in this example, the read pointer cyclically counts “1” to “16” according to the read clock.

In the FIFO memory 110 described above, a data signal is written to a memory element specified by a write pointer, and a data signal is read from a memory element specified by a read pointer. In this case, the write pointer is incremented by one. Therefore, the data signals are written sequentially from the memory element b1 of the ring buffer 111. The read pointer is also incremented by one. Therefore, the data signals stored in the ring buffer 111 are read sequentially from the memory element b1. In the example illustrated in FIG. 2, the write pointer is “14”, and the read pointer is “11”. Namely, FIG. 2 illustrates a state in which a new data signal is written to a memory element b14 according to the write pointer and a data signal is read from a memory element b11 according to the read pointer. As a result, valid data signals are stored in memory elements b12-b14.

The pointer difference detector 121 detects a difference between a write pointer and a read pointer. In this case, the pointer difference detector 121 calculates the difference by subtracting the read pointer from the write pointer. In the example illustrated in FIG. 2, for example, the write pointer is “14”, and the read pointer is “11”. Therefore, “a difference=3” is obtained. When the read pointer is greater than the write pointer, the difference is calculated by adding the number of memory elements of the ring buffer 111 to a value obtained by subtracting the read pointer from the write pointer. As an example, when the write pointer is “2” and the read pointer is “14”, “a difference=4 (=2-14+16)” is obtained. In the description below, the difference between the write pointer and the read pointer may be referred to as a “pointer difference”.

A pointer difference corresponds to the amount of valid data signals stored in the ring buffer 111. In the example illustrated in FIG. 2, the pointer difference is “3”, and a data signal of 3 bits is stored in b12-b14 of the ring buffer 111. In the description below, the amount of valid data signals stored in the ring buffer 111 may be referred to as a “valid data length”.

The memory size of the ring buffer 111 is known. Therefore, the pointer difference substantially represents a usage rate of the ring buffer 111. The usage rate of the ring buffer 111 is represented by a ratio of a valid data length to the memory size of the ring buffer 111. In this example, the memory size is “16”, and the valid data length is “3”, and therefore the usage rate is “3/16”. Here, the valid data length uniquely corresponds to the pointer difference. Accordingly, the pointer difference detector 121 can detect the usage rate of the ring buffer 111 according to the pointer difference. In addition, the pointer difference and the usage rate of the ring buffer 111 uniquely correspond to each other.

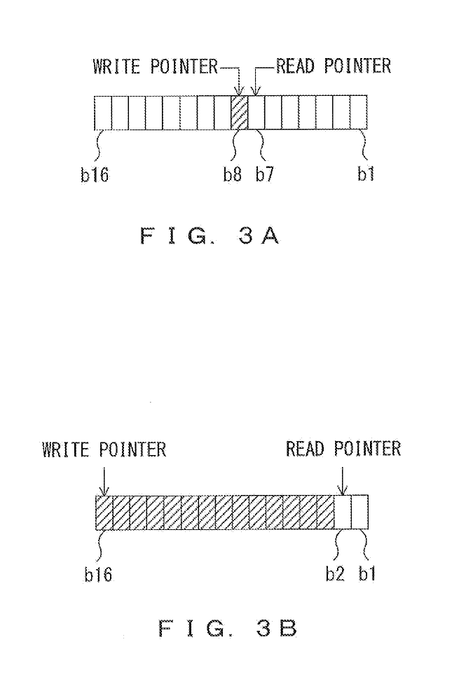

The comparator 122 determines whether the pointer difference (or the usage rate of the ring buffer 111) is within a specified allowable range. Here, the allowable range is represented by an upper limit value and a lower limit value that have been specified in advance. Therefore, the comparator 122 compares the pointer difference with the upper limit value and the lower limit value. With reference to FIGS. 3A and 3B, the allowable range of the pointer difference (or the usage rate of the ring buffer 111) is described below.

As described above, the write pointer is incremented by the write clock, and the read pointer is incremented by the read clock. Therefore, when a frequency of the read clock is higher than a frequency of the write clock, the pointer difference decreases, and the usage rate of the ring buffer 111 decreases, as illustrated in FIG. 3A. When the pointer difference becomes zero, the ring buffer 111 becomes “empty”, and a signal error whereby a data signal fails to be output occurs.

When a frequency of the read clock is lower than a frequency of the write clock, the pointer difference increases, and the usage rate of the ring buffer 111 increases, as illustrated in FIG. 3B. When the pointer difference increases up to the memory size of the ring buffer 111, the ring buffer 111 becomes “full”, and a signal error whereby a data signal is discarded occurs.

Considering the above, it is estimated that, when the usage rate of the ring buffer 111 is 50 percent, a signal error is least likely to occur. Namely, an optimum value of the pointer difference (or the valid data length) is half the memory size of the ring buffer 111. In this example, the memory size of the ring buffer 111 is “16”. Therefore, the optimum value of the pointer difference (or the valid data length) is “8”.

The allowable range of the pointer difference is determined according to the optimum value of the pointer difference. As an example, the allowable range is represented by an optimum value±n. n is, for example, an integer that is less than a quarter of the memory size of the ring buffer 111. As an example, n might be one-eighth of the memory size of the ring buffer 111. In this case, n=2 in the example illustrated in FIG. 2, and therefore the allowable range is “6-10”. In other words, an upper limit value and a lower limit value of the pointer difference are “10” and “6”, respectively.

The frequency controller 123 generates a frequency control signal according to a comparison result of the comparator 122. Specifically, when the pointer difference is greater than the upper limit value of the allowable range, the frequency controller 123 generates a first frequency control signal. The first frequency control signal indicates an instruction to increase the frequency of the read clock. When the pointer difference is less than the lower limit value of the allowable range, the frequency controller 123 generates a second frequency control signal. The second frequency control signal indicates an instruction to reduce the frequency of the read clock.

The pointer difference uniquely corresponds to the usage rate of the ring buffer 111, as described above. Therefore, the operation of the frequency controller 123 can be described as follows. When the usage rate of the ring buffer 111 is greater than an upper limit value of a specified allowable range, the frequency controller 123 generates the first frequency control signal. When the usage rate of the ring buffer 111 is less than an upper limit value of a specified allowable range, the frequency controller 123 generates the second frequency control signal.

The frequency control signal generated by the frequency controller 123 is given to the PLL circuit 130. The PLL circuit 130 includes a VCO (Voltage Controlled Oscillator) 131, a division circuit 132, and a phase comparator 133.

The VCO 131 oscillates at a frequency that corresponds to a given instruction signal so as to generate the read clock. The instruction signal is generated by the phase comparator 133. The division circuit 132 divides the read clock generated by the VCO 131 so as to generate a divided clock. The phase comparator 133 generates an instruction signal indicating a phase difference between the divided clock generated by the division circuit 132 and a reference clock. The instruction signal is a voltage signal that controls an oscillation frequency of the VCO 131. The division circuit 132 has a function of resetting a division operation when the frequency control signal is given from the frequency controller 123. The resetting of the division operation is described later in detail.

The PLL circuit 130 operates such that a phase difference between the divided clock and the reference clock becomes zero. Accordingly, the PLL circuit 130 generates a read clock synchronized with the reference clock.

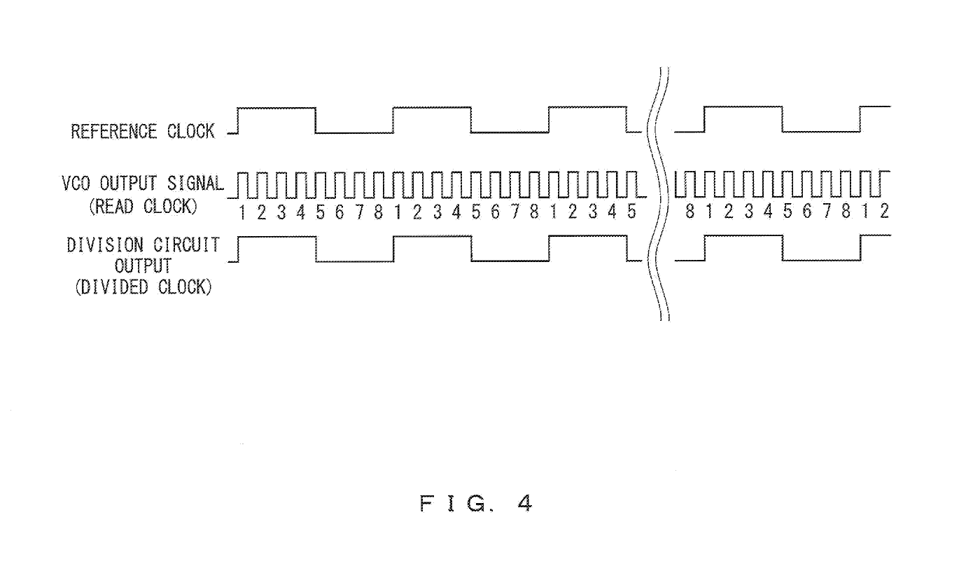

FIG. 4 illustrates an example of an operation of the PLL circuit 130. In this example, the division circuit 132 divides an output signal (that is, the read clock) of the VCO 131 into eight pieces. In FIG. 4, cycle numbers 1-8 are assigned to the read clock for the explanation of the division operation.

The division circuit 132 generates a 1-cycle divided clock during a period during which 8-cycle read clocks are counted. In the example illustrated in FIG. 4, the divided clock is generated such that the divided clock rises in synchronization with the first-cycle read clock, and falls in synchronization with the fifth-cycle read clock. The PLL circuit 130 operates such that the phase difference between the divided clock and the reference clock becomes zero. As a result, the PLL circuit 130 generates a read clock synchronized with the reference clock.

The PLL circuit 130 may be configured so as to include another tunable oscillator instead of the VCO 131. As an example, the PLL circuit 130 may be configured so as to include an NCO (Numerically Controlled Oscillator). In this case, an instruction signal generated by the phase comparator 133 is a digital code indicating the phase difference between the divided clock and the reference clock. The NCO oscillates at a frequency that corresponds to the digital code so as to output the read clock.

In addition, the PLL circuit 130 may include a loop filter 134 between the phase comparator 133 and the VCO 131. The loop filter 134 averages an instruction signal generated by the phase comparator 133. In other words, the loop filter 134 can average the instruction signal so as to reduce a change of an oscillation frequency of the VCO 131 (that is, the frequency of the read clock).

When a data signal is input to the FIFO circuit 100, the data signal is written to the ring buffer 111 in accordance with the write pointer. The data signal written to the ring buffer 111 is read in accordance with the read pointer. The data signal read from the ring buffer 111 is processed by a signal processing circuit 140.

Here, it is assumed that the FIFO circuit 100 is implemented in the transmission device 1 illustrated in FIG. 1. In this case, a data signal is generated in synchronization with the reference clock generated by the oscillator 16, and the write clock is recovered from the data signal. On the other hand, the read clock is generated in synchronization with the reference clock in the PLL circuit 130, as illustrated in FIG. 2. Therefore, the write clock and the read clock are synchronized with each other. Namely, an average frequency of the write clock and an average frequency of the read clock are substantially the same as each other.

When the frequency of the write clock is the same as the frequency of the read clock, the difference between the write pointer and the read pointer is constant. Namely, when an initial operation of the FIFO circuit is approximately set, the ring buffer 111 does not become “empty” or “full”.

However, a phase of a data signal may be shifted with respect to time. When the phase of the data signal is shifted, the frequency of the write clock recovered from the data signal is changed. As a result, the frequency of the write clock is different from the frequency of the read clock, and therefore the difference between the write pointer and the read pointer is changed. In this case, the ring buffer 111 may become “empty” or “full”. In view of the foregoing, the FIFO circuit 100 according to the first embodiment has a function of monitoring the difference between the write pointer and the read pointer and controlling the frequency of the read clock according to the difference.

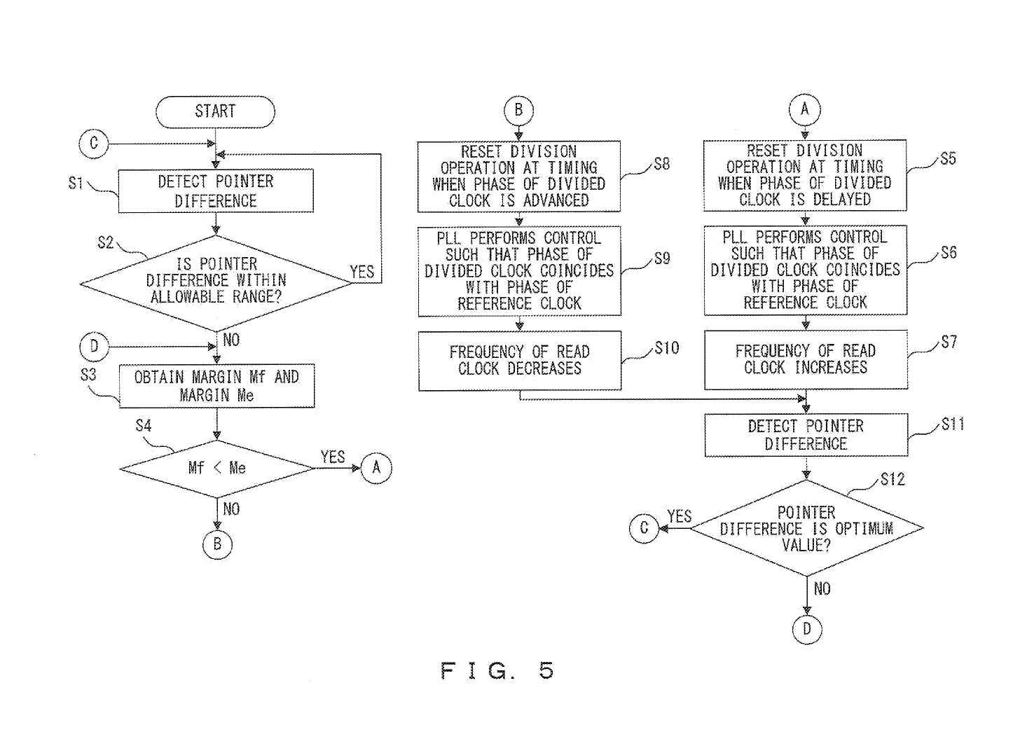

FIG. 5 is a flowchart illustrating a method for controlling a FIFO circuit according to the first embodiment. Processes in this flowchart are repeatedly performed while the FIFO circuit 100 is operating.

In S1, the pointer difference detector 121 detects a difference between the write pointer and the read pointer of the ring buffer 111. In the description below, the difference may be referred to as a “pointer difference”. In S2, the comparator 122 decides whether the pointer difference is within an allowable range. The allowable range is, for example, an optimum value of the pointer difference±n. The optimum value of the pointer difference is, for example, half the memory size of the ring buffer 111. When the pointer difference is within the allowable range, the control operation returns to S1. When the pointer difference is out of the allowable range, the control operation moves on to S3.

In S3 and S4, the comparator 122 obtains a margin Mf until the ring buffer 111 becomes “full”, and a margin Me until the ring buffer 111 becomes “empty”. The margin Mf corresponds to a difference between the memory size of the ring buffer 111 and the pointer difference. The margin Me corresponds to a difference between the pointer difference and “zero” (that is, the pointer difference itself). When the margin Mf is less than the margin Me, it is determined that the ring buffer 111 may become “full”, and the control operation moves on to S5. When the margin Mf is greater than or equal to the margin Me, it is determined that the ring buffer 111 may become “empty”, and the control operation moves on to S8. Note that when the margin Mf equals to the margin Me in S4, the control operation may return to S1.

The processes of S3 and S4 may be realized by determining whether the pointer difference is within the allowable range. In this case, when the pointer difference is greater than an upper limit value of the allowable range, it is determined that the ring buffer 111 may become “full”, and the control operation moves on to S5. When the pointer difference is less than a lower limit value of the allowable range, it is determined that the ring buffer 111 may become “empty”, and the control operation moves on to S8.

When it is determined that the ring buffer 111 may become “full”, S5 to S7 are performed. Specifically, in S5, the frequency controller 123 generates the first frequency control signal indicating an instruction to increase a frequency of the read clock. Then, in the PLL circuit 130, the division circuit 132 resets a division operation at a timing when a phase of a divided clock is delayed. As a result, the phase of the divided clock is delayed. In S6, the PLL circuit 130 operates such that a phase difference between the divided clock and a reference clock becomes zero. Namely, the divided clock delayed in S5 is controlled so as to catchup with a phase of the reference clock. In this case, the phase of the divided clock is advanced, and therefore a frequency of the divided clock increases. Accordingly, in S7, the frequency of the read clock also increases.

When the frequency of the read clock increases, a speed at which a data signal is read from the ring buffer 111 increases. As a result, a valid data length of the ring buffer 111 decreases, and a possibility of the ring buffer 111 becoming “full” is suppressed.

When it is determined that the ring buffer 111 may become “empty”, S8 to S10 are performed. Specifically, in S8, the frequency controller 123 generates the second frequency control signal indicating an instruction to reduce a frequency of the read clock. Then, in the PLL circuit 130, the division circuit 132 resets a division operation at a timing when the phase of the divided clock is advanced. As a result, the phase of the divided clock is advanced. In S9, the PLL circuit 130 operates such that a phase difference between the divided clock and the reference clock becomes zero. Namely, the divided clock advanced in S8 is controlled so as to coincide with a phase of the reference clock. In this case, the phase of the divided clock is delayed, and therefore a frequency of the divided clock decreases. Accordingly, in S10, the frequency of the read clock also decreases.

When the frequency of the read clock decreases, a speed at which a data signal is read from the ring buffer 111 decreases. As a result, a valid data length of the ring buffer 111 increases, and a possibility of the ring buffer 111 becoming “empty” is suppressed.

In S11-S12, the pointer difference detector 121 detects a pointer difference of the ring buffer 111, and the comparator 122 determines whether the pointer difference coincides with an optimum value. When the pointer difference coincides with the optimum value, the control operation moves on to S1. When the pointer difference does not coincide with the optimum value, the control operation moves on to S3. Namely, the processes of S3-S11 are repeatedly performed until the pointer difference coincides with the optimum value. As a result, the ring buffer 111 is controlled so as to be in a state in which “full” and “empty” are not likely to occur.

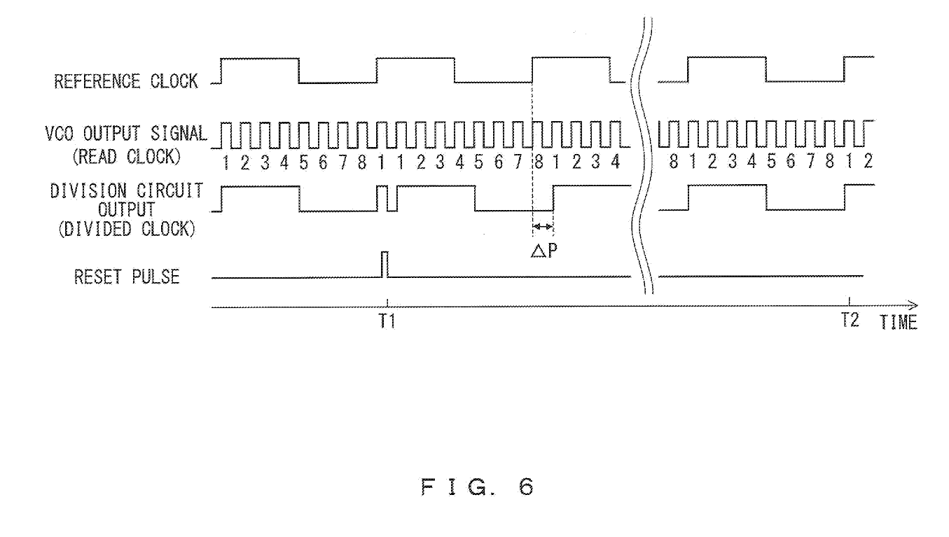

FIG. 6 is a time chart illustrating an operation when it is determined that the ring buffer 111 may become “full”. Note that, before time T1, the phase of the divided clock coincides with the phase of the reference clock. The read clock is divided into eight pieces by the division circuit 132. Namely, a one-cycle divided clock is generated for 8-cycle read clocks. In the description below, 8-cycle read clocks that correspond to each of the divided clocks may be referred to as CK1-CK8, respectively.

When it is determined that the ring buffer 111 may become “full”, the first frequency control signal indicating an instruction to increase the frequency of the read clock is given to the PLL circuit 130, as described above. Then, the division circuit 132 resets the division operation of the division circuit 132 at time T1. Resetting of the division operation is realized, for example, by the division circuit 132 generating a reset pulse. In this case, the reset pulse is generated at a timing when the phase of the divided clock is delayed. Specifically, the reset pulse is generated immediately after a new divided clock is started. As an example, the reset pulse is generated in CK1.

When the division operation is reset at the above timing, the division circuit 132 starts a new cycle of the divided clock immediately after the resetting. As a result, the divided clock is delayed with respect to the reference clock. In the example illustrated in FIG. 6, the divided clock is delayed with respect to the reference clock by ΔP.

After that, the PLL circuit 130 operates such that the phase of the divided clock coincides with the phase of the reference clock. Therefore, the phase comparator 133 generates an instruction signal to advance the phase of the divided clock. Then, the VCO 131 changes an oscillation frequency according to the instruction signal. In order to advance the phase of the divided clock, it is preferable that the oscillation frequency of the VCO 131 increase. Accordingly, the phase comparator 133 generates an instruction signal to increase the frequency of the VCO 131 in order to advance the phase of the divided clock. As a result, the oscillation frequency of the VCO 131 increases, and the phase of the divided clock is advanced. In the example illustrated in FIG. 6, at time T2, the phase of the divided clock coincides with the phase of the reference clock.

As described above, during T1-T2, the oscillation frequency of the VCO 131 is higher than 8 times the frequency of the reference clock. After time T2, the oscillation frequency of the VCO 131 is maintained so as to be 8 times the frequency of the reference clock.

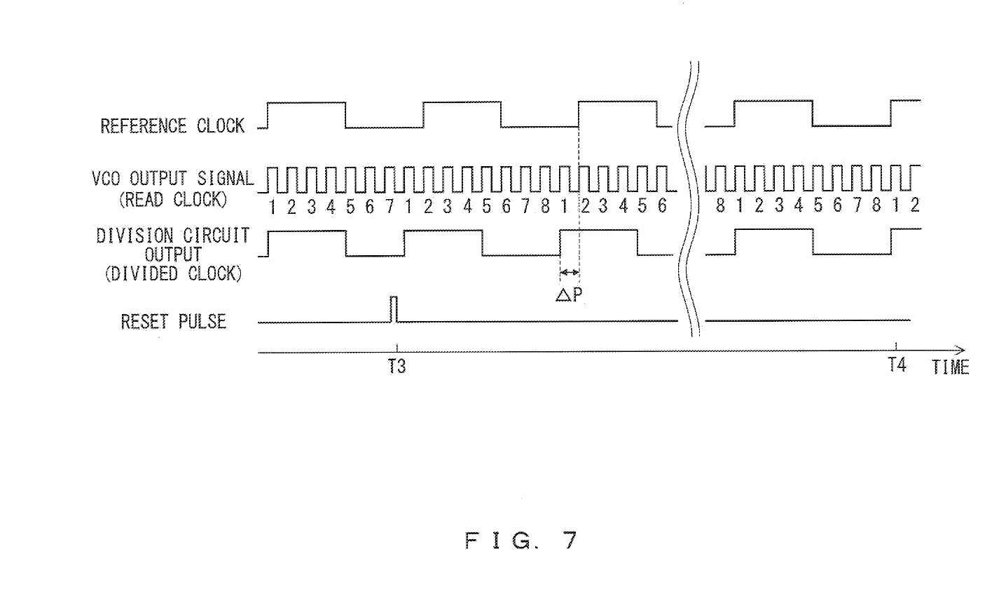

FIG. 7 is a time chart illustrating an operation when it is determined that the ring buffer 111 may become “empty”. Note that before time T3, the phase of the divided clock coincides with the phase of the reference clock.

When it is determined that the ring buffer 111 may become “empty”, the second frequency control signal indicating an instruction to reduce the frequency of the read clock is given to the PLL circuit 130, as described above. Then, the division circuit 132 generates a reset pulse to reset the division operation of the division circuit 132 at time T3. The reset pulse is generated at a timing when the phase of the divided clock is advanced. Specifically, the reset pulse is generated immediately before the divided clock is finished. As an example, the reset pulse is generated in CK8.

When the division operation is reset at the above timing, the division circuit 132 starts a new cycle of the divided clock immediately after the resetting. As a result, the divided clock is advanced with respect to the reference clock. In the example illustrated in FIG. 7, the divided clock is advanced with respect to the reference clock by ΔP.

After that, the PLL circuit 130 operates such that the phase of the divided clock coincides with the phase of the reference clock. Therefore, the phase comparator 133 generates an instruction signal to delay the phase of the divided clock. Then, the VCO 131 changes an oscillation frequency according to the instruction signal. In order to delay the phase of the divided clock, it is preferable that the oscillation frequency of the VCO 131 be reduced. Accordingly, the phase comparator 133 generates an instruction signal to reduce the frequency of the VCO 131 in order to delay the phase of the divided clock. As a result, the oscillation frequency of the VCO 131 decreases, and the phase of the divided clock is delayed. In the example illustrated in FIG. 7, the phase of the divided clock coincides with the phase of the reference clock at time T4.

As described above, during T3-T4, the oscillation frequency of the VCO 131 is lower than 8 time the frequency of the reference clock. After time T4, the oscillation frequency of the VCO 131 is maintained so as to be 8 times the frequency of the reference clock.

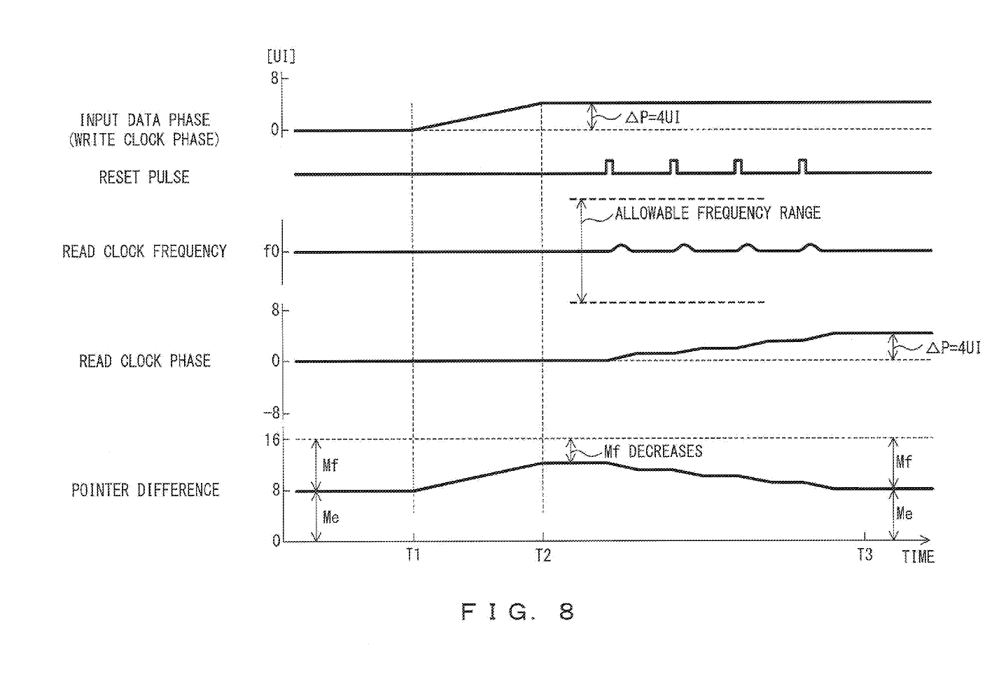

FIG. 8 illustrates an example of an operation of the FIFO circuit 100 according to the first embodiment. In this example, before time T1, the pointer difference is 8. Namely, the pointer difference is controlled so as to have an optimum value.

During T1-T2, a phase of an input data signal is shifted, and a frequency of the write clock slightly increases. As a result, a speed at which a data signal is written to the ring buffer 111 is higher than a speed at which a data signal is read from the ring buffer 111, and the pointer difference increases.

At time T2, the pointer difference exceeds an upper limit of an allowable range, and a margin Mf against “full” is smaller than a threshold. Then, the first frequency control signal indicating an instruction to increase the frequency of the read clock is generated, and in the PLL circuit 130, the division operation is reset at a timing when the divided clock is delayed. The PLL circuit 130 advances the phase of the divided clock so as to make the delayed divided clock coincide with the reference clock. As a result, the oscillation frequency of the VCO 131 (that is, the frequency of the read clock) increases, and the pointer difference decreases, as described with reference to FIG. 6.

After that, the operation above is repeatedly performed until the pointer difference returns to the optimum value. In the example illustrated in FIG. 8, the phase of the write clock is shifted by 4 UI due to a shift in the phase of the input data signal. Therefore, during T2-T3, an operation to reset the division operation is performed four times, and as a result, the pointer difference is adjusted so as to have the optimum value. Note that UI corresponds to a ratio of “1 bit” to the memory size of the ring buffer 111.

As described above, in the FIFO circuit 100 according to the first embodiment, when the pointer difference deviates from the allowable range, the frequency of the read clock is controlled so as to adjust the pointer difference to close to the optimum value. In this case, when the frequency of the read clock is changed, a frequency of an output data signal is changed. When a change in a frequency of a data signal is great, a bit error may occur. Accordingly, it is preferable that the frequency of the output data signal be controlled to be within an allowable frequency range.

Therefore, the PLL circuit 130 has a function of maintaining a change in the frequency of the read clock due to resetting of the division operation within the allowable frequency range. The PLL circuit 130 includes the loop filter 134 that filters the instruction signal generated by the phase comparator 133. A filter coefficient of the loop filter 134 is determined such that the change in the frequency of the read clock due to resetting of the division operation is within a specified allowable frequency range. In this configuration, the frequency of the output data signal is controlled so as to be within the allowable frequency range.

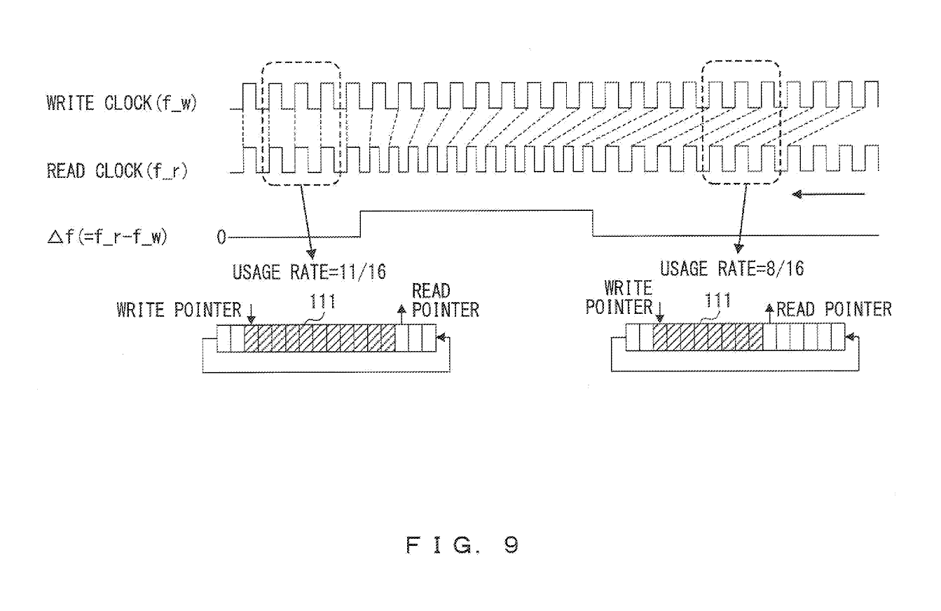

FIG. 9 illustrates an example of an effect according to the first embodiment. In this example, the pointer difference of the ring buffer 111 is “11”, and a memory usage rate “11/16” is detected. Note that the memory usage rate is calculated by a ratio of the pointer difference to the memory size. An optimum value of the memory usage rate is “8/16”. The detected memory usage rate “11/16” is assumed to be out of a specified allowable range.

In this case, the FIFO circuit 100 performs the control operation illustrated in FIG. 6 or FIG. 8. As a result, the frequency of the read clock is higher than the frequency of the write clock, and a frequency difference Δf is generated. Δf represents a difference between the frequency of the write clock and the frequency of the read clock. Accordingly, the pointer difference gradually decreases. Namely, the memory usage rate decreases. A state in which the frequency of the read clock is controlled to be higher is maintained until the memory usage rate coincides with the optimum value. In the example illustrated in FIG. 9, during a period after a state in which the memory usage rate deviates from the allowable range is detected and before the memory usage rate coincides with the optimum value, the read clock is advanced by 3 bits. Note that the effect illustrated in FIG. 9 may be obtained similarly in the second embodiment described later.

As described above, the FIFO circuit 100 has a function of controlling the frequency of the read clock according to the pointer difference or usage rate of the ring buffer 111. Here, the pointer difference corresponds to the valid data length of the ring buffer 111. Namely, the pointer difference corresponds to the usage rate of the ring buffer 111. Accordingly, an operation to control the frequency of the read clock according to the pointer difference of the ring buffer 111 is substantially equivalent to an operation to control the frequency of the read clock according to the usage rate of the ring buffer 111.

### Second Embodiment

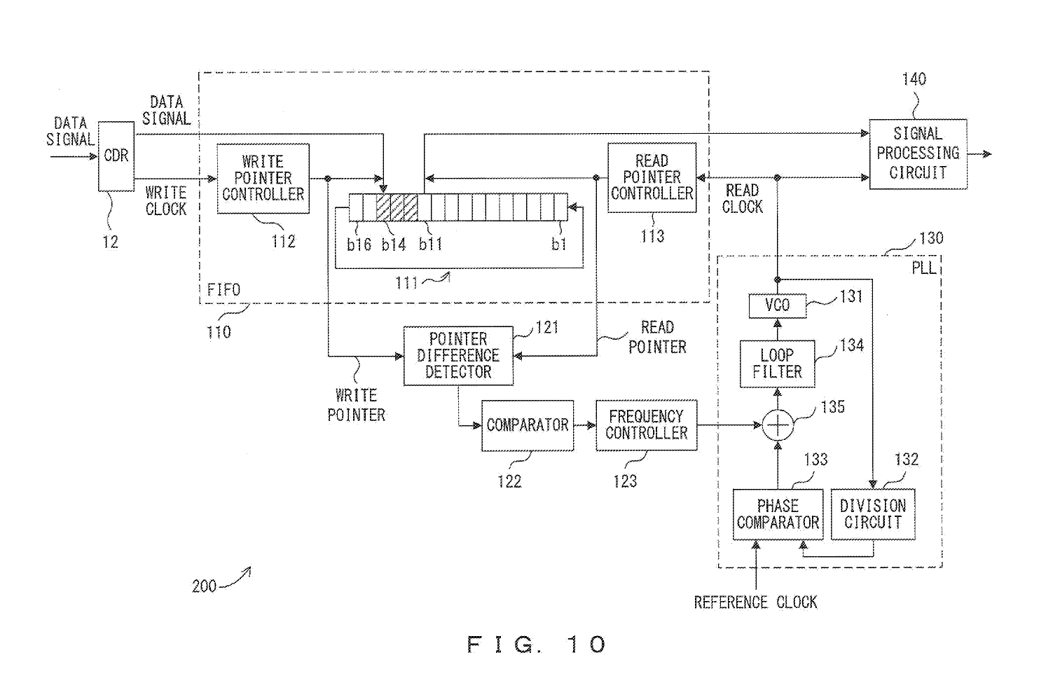

FIG. 10 illustrates an example of a FIFO circuit according to the second embodiment. A FIFO circuit 200 according to the second embodiment has a configuration that is similar to that of the FIFO circuit 100 according to the first embodiment illustrated in FIG. 2. However, the second embodiment is different from the first embodiment in a configuration and an operation of a circuit that generates the read clock (in this example, the PLL circuit 130).

The PLL circuit 130 according to the second embodiment includes a VCO 131, a division circuit 132, a phase comparator 133, and an adder 135, as illustrated in FIG. 10. The VCO 131, the division circuit 132, and the phase comparator 133 according to the second embodiment are substantially the same as those according to the first embodiment. However, in the second embodiment, the division circuit 132 does not need to have a resetting function according to the first embodiment. An instruction signal generated by the phase comparator 133 is a control voltage signal that controls the oscillation frequency of the VCO 131. In this example, it is assumed that, as an applied control voltage increases, the oscillation frequency of the VCO 131 increases.

The frequency controller 123 generates a frequency control signal according to the pointer difference of the ring buffer 111 (or according to the usage rate of the ring buffer 111), similarly to the first embodiment. However, in the second embodiment, when the pointer difference is greater than an upper limit value of an allowable range, the frequency controller 123 generates a positive voltage control pulse as the first frequency control signal. When the pointer difference is less than a lower limit value of the allowable range, the frequency controller 123 generates a negative voltage control pulse as the second frequency control signal.

The adder 135 adjusts the control voltage signal in accordance with the frequency control signal generated by the frequency controller 123. Specifically, the adder 135 superimposes the control pulse generated by the frequency controller 123 onto the control voltage signal. As an example, when the pointer difference of the ring buffer 111 is greater than the upper limit value of the allowable range, the frequency controller 123 generates a positive voltage control pulse. In this case, the adder 135 superimposes the positive voltage control pulse onto the control voltage signal, and the control voltage increases by an amount of the positive voltage control pulse. As a result, the oscillation frequency of the VCO 131 (that is, the frequency of the read clock) temporality increases. When the pointer difference of the ring buffer 111 is less than the lower limit value of the allowable range, the frequency controller 123 generates a negative voltage control pulse. In this case, the adder 135 superimposes the negative voltage control pulse onto the control voltage signal, and the control voltage decreases by an amount of the negative voltage control pulse. As a result, the oscillation frequency of the VCO 131 temporarily decreases.

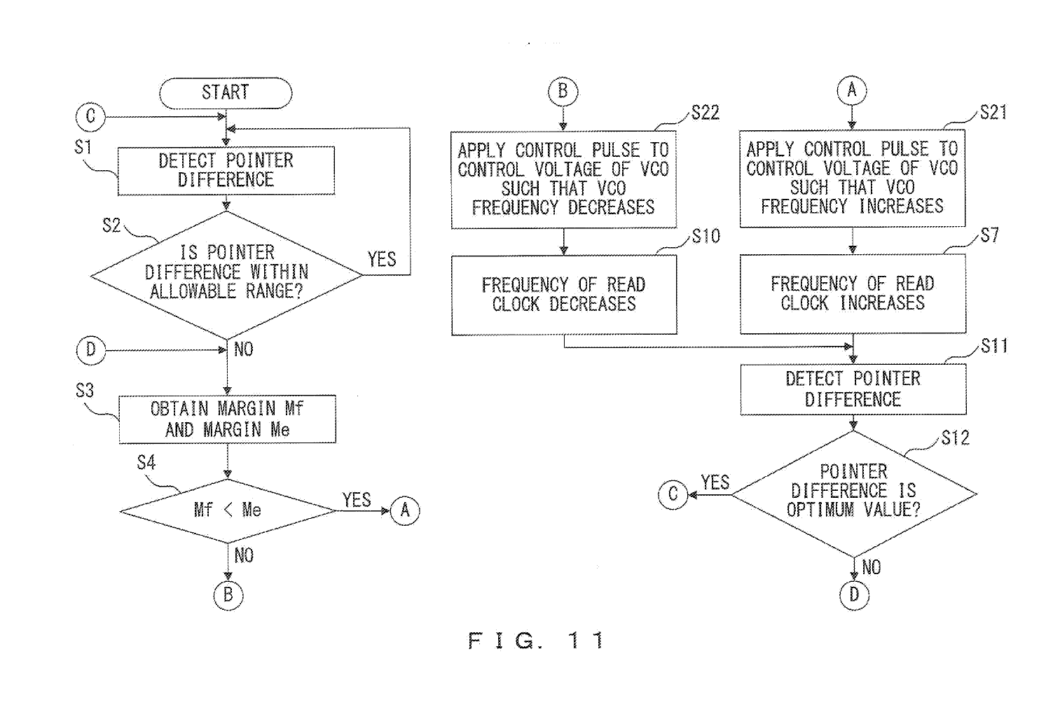

FIG. 11 is a flowchart illustrating a method for controlling a FIFO circuit according to the second embodiment. The method for controlling the FIFO circuit according to the second embodiment is similar to the method for controlling the FIFO circuit according to the first embodiment illustrated in FIG. 5. However, in the second embodiment, when a margin Mf is less than a margin Me (that is, when it is determined that the ring buffer 111 may become “full”), the process of S21 is performed instead of the processes of S5-S6 illustrated in FIG. 5. When a margin Mf is greater than or equal to a margin Me (that is, when it is determined that the ring buffer 111 may become “empty”), the process of S22 is performed instead of the processes of S8-S9 illustrated in FIG. 5. Note that when the margin Mf equals to the margin Me in S4, the control operation may return to S1.

When it is determined that the ring buffer 111 may become “full”, the frequency controller 123 generates a positive voltage control pulse in S21. Then, in the PLL circuit 130, the adder 135 superimposes the positive voltage control pulse onto the control voltage signal. As a result, a control voltage applied to the VCO 131 temporarily increases. Consequently, in S7, the oscillation frequency of the VCO 131 (that is, the frequency of the read clock) increases.

When it is determined that the ring buffer 111 may become “empty”, the frequency controller 123 generates a negative voltage control pulse in S22. Then, in the PLL circuit 130, the adder 135 superimposes the negative voltage control pulse onto the control voltage signal. Accordingly, a control voltage applied to the VCO 131 temporarily decreases. Consequently, in S10, the oscillation frequency of the VCO 131 (that is, the frequency of the read clock) decreases.

Then in S11-S12, the pointer difference detector 121 determines whether the pointer difference of the ring buffer 111 coincides with an optimum value. When the pointer difference coincides with the optimum value, the control operation returns to S1. When the pointer difference does not coincide with the optimum value, the control operation moves on to S3. Namely, the processes S3-S11 illustrated in FIG. 11 are repeatedly performed until the pointer difference coincides with the optimum value. As a result, the ring buffer 111 is controlled to be in a state in which “full” and “empty” are not likely to occur.

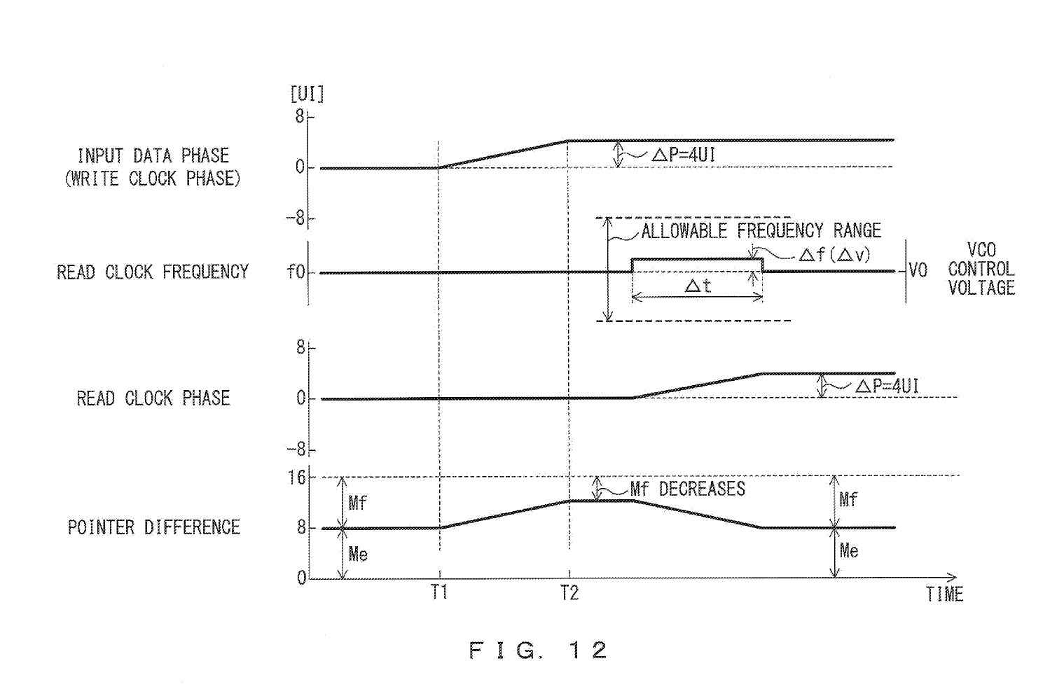

FIG. 12 illustrates an example of an operation of the FIFO circuit 200 according to the second embodiment. Similarly to the example illustrated in FIG. 8, before time t1, the pointer difference is controlled so as to have an optimum value. During T1-T2, a phase of an input data signal is shifted, and the pointer difference of the ring buffer 111 gradually increases. In time T2, the pointer difference exceeds an upper limit value of an allowable range, and a margin Mf against “full” is less than a threshold.

When the pointer difference exceeds the upper limit value of the allowable range, the frequency controller 123 generates a positive voltage control pulse, and in the PLL circuit 130, the positive voltage control pulse is superimposed onto the control voltage signal of the VCO 131. Namely, the control voltage of the VCO 131 increases by ΔV, and the oscillation frequency of the VCO 131 (that is, the frequency of the read clock) increases by Δf. As a result, the pointer difference of the ring buffer 111 decreases. After that, the operation above is repeatedly performed until the pointer difference returns to the optimum value.

In this example, the oscillation frequency of the VCO 131 uniquely depends on the control voltage applied to the VCO 131. Accordingly, a change amount Δf of the frequency of the VCO 131 due to the superimposition of the control pulse to the control voltage signal depends on a height (or amplitude) ΔV of the control pulse (the positive voltage control pulse or the negative voltage control pulse). Here, it is preferable that a change in the frequency of the read clock be maintained within a specified allowable frequency range. Therefore, the height ΔV of the control pulse is determined such that the change amount Δf of the frequency of the read clock is maintained within the specified allowable frequency range.

In addition, similarly to the first embodiment, the PLL circuit 130 may be configured to include a frequency tunable oscillator having another configuration, instead of the VCO 131. As an example, when an NCO is implemented instead of the VCO 131, the frequency controller 123 generates frequency control data indicating a change amount of a frequency. The adder 135 adds the frequency control data to a digital code generated by the phase comparator 133. Then, the NCO oscillates at a frequency that corresponds to the digital code so as to output a read clock.

### Third Embodiment

The examples illustrated in FIGS. 2-12 relate to a configuration in which a data signal is read from a single FIFO circuit. On the other hand, the example described below relates to a configuration in which data signals are read from a plurality of FIFO circuits by using a common clock in order to establish the synchronization of a plurality of data signals.

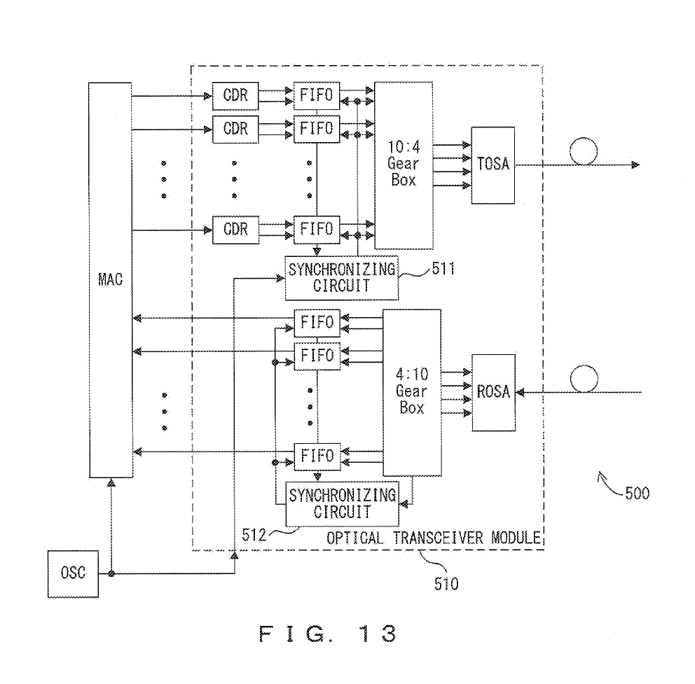

FIG. 13 illustrates an example of a configuration of a transmission device using a synchronizing circuit according to the embodiments. A transmission device 500 includes an optical transceiver module 510. The optical transceiver module 510 includes a transmitter circuit that generates and transmits a WDM optical signal including a plurality of data signals, and a receiver circuit that recovers a plurality of data signals from a received WDM optical signal.

A synchronizing circuit 511 provided in the transmitter circuit performs control to read transmission data signals in parallel from a plurality of FIFO memories. A synchronizing circuit 512 provided in the receiver circuit performs control to read received data signals in parallel from a plurality of FIFO memories.

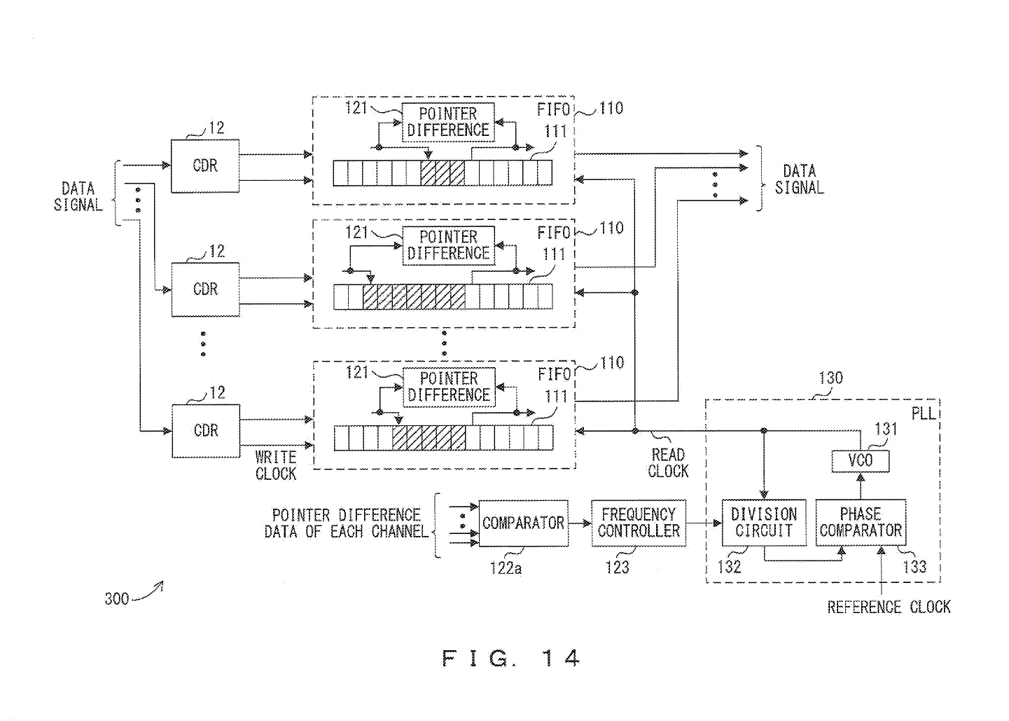

FIG. 14 illustrates an example of a FIFO circuit according to the third embodiment. A FIFO circuit 300 according to the third embodiment includes a plurality of FIFO memories 110, a plurality of pointer difference detectors 121, a comparator 122a, a frequency controller 123, and a PLL circuit 130. Write pointer controllers are respectively provided for the ring buffers 111 of the plurality of FIFO memories 110, although this is omitted in FIG. 14. Each of the write pointer controllers generates a write pointer by using a write clock recovered by a corresponding Clock Data Recovery (CDR) 12. In addition, a read pointer controller shared by the plurality of FIFO memories 110 is provided. The read pointer controller generates a read pointer by using a read clock generated by the PLL circuit 130.

The FIFO circuit 300 is used, for example, in the transmission device 500 illustrated in FIG. 13. When the FIFO circuit 300 is used in the transmitter circuit of the transmission device 500, the plurality of pointer difference detectors 121, the comparator 122a, the frequency controller 123, and the PLL circuit 130 configure the synchronizing circuit 511. When the FIFO circuit 300 is used in the receiver circuit of the transmission device 500, the plurality of pointer difference detectors 121, the comparator 122a, the frequency controller 123, and the PLL circuit 130 configure the synchronizing circuit 512.

The comparator 122a collects pointer difference data indicating a pointer difference detected in each of the FIFO memories 110. Then, the comparator 122a and the frequency controller 123 control a frequency of the read clock according to the collected pointer difference data.

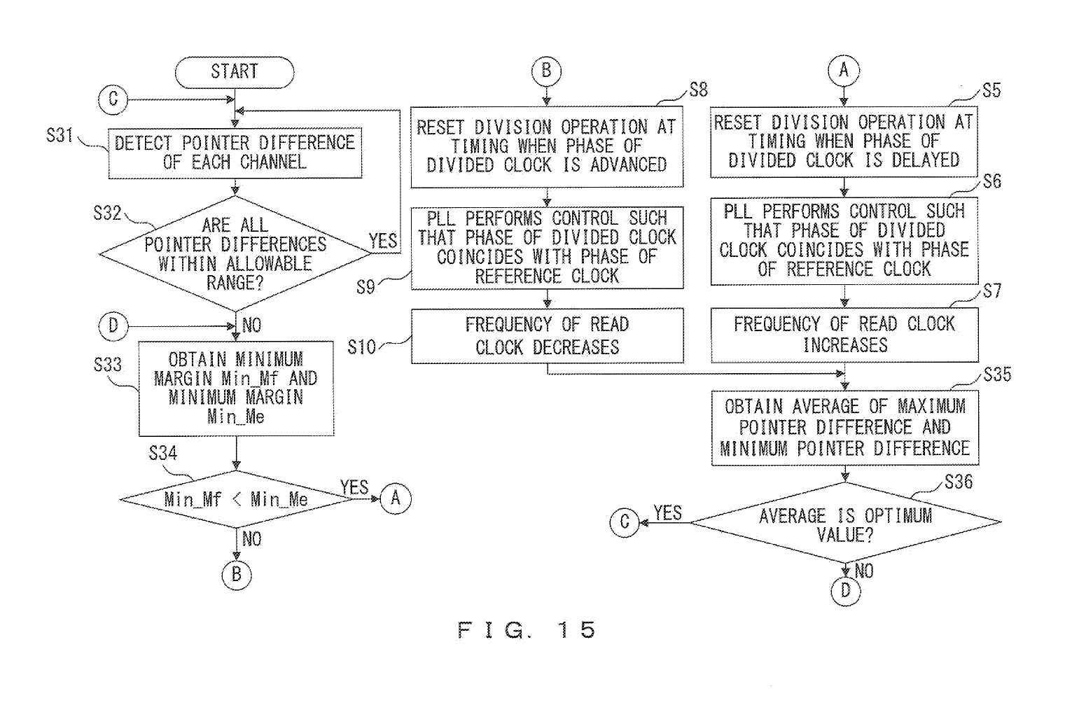

FIG. 15 is a flowchart illustrating a method for controlling a FIFO circuit according to the third embodiment. Processes in this flowchart are repeatedly performed while the FIFO circuit 300 is operating.

In S31, the pointer difference detector 121 of each of the channels detects a difference between the write pointer and the read pointer. In the description below, the difference may be referred to as a “pointer difference”. In S32, the comparator 122a determines whether pointer differences of all of the channels are within an allowable range. The allowable range may be the same as that in the first or second embodiment. When pointer differences of all of the channels are within an allowable range, the control operation returns to S31. When pointer differences of one or more channels are out of an allowable range, the control operation moves on to S33.

In S33-S34, the comparator 122a obtains a margin Mf until the ring buffer 111 for each of the channels becomes “full”, and a margin Me until the ring buffer 111 becomes “empty”. Then, the comparator 122a selects a minimum margin Min_Mf from among margins Mf of all of the channels, and selects a minimum margin Min_Me from among margins Me of all of the channels. When the minimum margin Min_Mf is less than the minimum margin Min_Me, it is determined that a channel for which the ring buffer 111 may become “full” exists, and the control operation moves on to S5. When the minimum margin Min_Mf is greater than or equal to the minimum margin Min_Me, it is determined that a channel for which the ring buffer 111 may become “empty” exists, and the control operation moves on to S8.

The processes of S5-S10 are substantially the same as those in the first embodiment. Namely, when it is determined that a channel for which the ring buffer 111 may become “full” exists, the PLL circuit 130 is controlled so as to increase the frequency of the read clock. When it is determined that a channel for which the ring buffer 111 may become “empty” exists, the PLL circuit 130 is controlled so as to reduce the frequency of the read clock. In the example illustrated in FIG. 15, S5-S10 in the first embodiment are performed; however, S7, S8, S21, and S22 in the second embodiment may be performed.

In S35-S36, the pointer difference detector 121 detects a pointer difference of each of the channels. The comparator 122a detects a maximum pointer difference and a minimum pointer difference from among the pointer differences of all of the channels. The comparator 122a also calculates an average of the maximum pointer difference and the minimum pointer difference. The comparator 122a then determines whether the calculated average pointer difference coincides with an optimum value. When the average pointer difference coincides with an optimum value, the control operation returns to S31. When the average pointer difference does not coincide with an optimum value, the control operation moves on to S33. Stated another way, the processes of S33-S35 are repeatedly performed until the average pointer difference coincides with the optimum value. Consequently, the ring buffer 111 of each of the FIFO memories 110 is controlled so as to close to a state in which “full” and “empty” are not likely to occur.

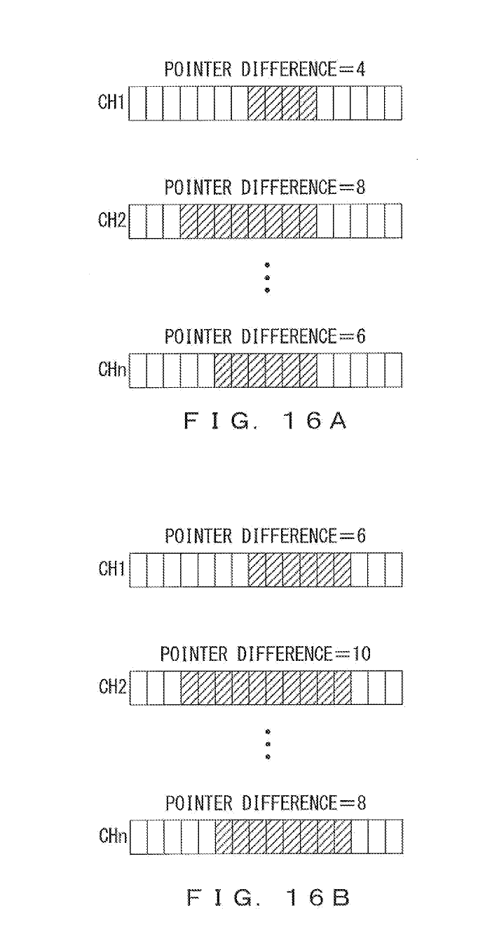

FIGS. 16A and 16B illustrate an example of an effect according to the third embodiment. In this example, a transmission device accommodates a plurality of channels CH1-CHn. As illustrated in FIG. 16A, a pointer difference of channel CH1 is the smallest, and a pointer difference of channel CH2 is the greatest. The memory size of the ring buffer 111 is 16 bits, and therefore an optimum value of the pointer difference is 8. A pointer difference of “4” of channel CH1 is assumed to be out of an allowable range.

In this example, a margin (Min_Me=4) of channel CH1 is less than a margin (Min_Mf=8) of channel CH2. In this case, the frequency controller 123 controls the PLL circuit 130 so as to reduce the frequency of the read clock. Here, the comparator 122a and the frequency controller 123 control the PLL circuit 130 such that an average of the pointer difference of channel CH1 and the pointer difference of channel CH2 coincides with the optimum value. Stated another way, the comparator 122a and the frequency controller 123 control the PLL circuit 130 until a state illustrated in FIG. 16B is obtained. As a result, the margin of channel CH1 is adjusted to be “6”, and the margin of channel CH2 also becomes “6”. Namely, compared with a state illustrated in FIG. 16A, the minimum margin increases from “4” to “6”, and therefore the ring buffer 111 of each of the channels is not likely to become “full” or “empty”.

In the third embodiment, a frequency of a common read clock used for a plurality of channels is controlled, and therefore pointer differences of the ring buffers 111 of all of the channels are adjusted by the same amount. In this example, when the state illustrated in FIG. 16A is shifted to the state illustrated in FIG. 16B, the pointer differences of the ring buffers 111 of all of the channels increase by 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission device comprising:
a write pointer controller that generates a write pointer by using a write clock recovered from a data signal;
a read clock generator that generates a read clock;
a read pointer controller that generates a read pointer by using the read clock;
a memory in which the data signal is written to a bit specified by the write pointer, and the data signal is read from a bit specified by the read pointer;
a detector that detects a usage rate of the memory according to a difference between the write pointer and the read pointer and;
a frequency controller that generates a frequency control signal that changes a frequency of the read clock when the usage rate is out of a specified allowable range, wherein
the read clock generator controls the frequency of the read clock according to the frequency control signal.

2. The transmission device according to claim 1, wherein
the frequency controller generates a first frequency control signal that increases the frequency of the read clock when the usage rate is greater than an upper limit value of the allowable range, and generates a second frequency control signal that reduces the frequency of the read clock when the usage rate is less than a lower limit value of the allowable range.

3. The transmission device according to claim 2, wherein
the read clock generator includes:
a frequency tunable oscillator that oscillates at a frequency that corresponds to a given instruction signal so as to generate the read clock;
a division circuit that divides the read clock so as to generate a divided clock; and
a phase comparator that generates the instruction signal indicating a phase difference between the divided clock and a reference clock, and
the division circuit resets a division operation so as to delay the divided clock when the first frequency control signal is generated by the frequency controller, and the division circuit resets the division operation so as to advance the divided clock when the second frequency control signal is generated by the frequency controller.

4. The transmission device according to claim 2, wherein
the read clock generator includes:
a frequency tunable oscillator that oscillates at a frequency that corresponds to a given instruction signal so as to generate the read clock;
a division circuit that divides the read clock so as to generate a divided clock;
a phase comparator that generates the instruction signal indicating a phase difference between the divided clock and a reference clock; and
an adjustment circuit that adjusts the instruction signal according to a frequency control signal generated by the frequency controller, and
the adjustment circuit adjusts the instruction signal so as to increase the frequency of the read clock when the first frequency control signal is generated by the frequency controller, and the adjustment circuit adjusts the instruction signal so as to reduce the frequency of the read clock when the second frequency control signal is generated by the frequency controller.

5. The transmission device according to claim 1, wherein
the detector detects the usage rate of the memory according to the difference between the write pointer and the read pointer and a size of the memory.

6. A transmission device comprising:
a plurality of FIFO (First-in First-out) memories;
a read clock generator that generates a read clock:
a detector that detects respective usage rates of the plurality of FIFO memories according to write pointers generated by using clocks of data signals that are respectively written to the plurality of FIFO memories and a read pointer generated by using the read clock; and
a frequency controller that outputs a frequency control signal that changes a frequency of the read clock when at least one of the usage rates of the plurality of FIFO memories is out of a specified allowable range, wherein
the read clock generator controls the frequency of the read clock according to the frequency control signal.

7. The transmission device according to claim 6, wherein
the frequency controller specifies a FIFO memory for which the usage rate has the greatest difference from a target usage rate among the usage rates of the plurality of FIFO memories, generates a first frequency control signal that increases the frequency of the read clock when the usage rate of the specified FIFO memory is greater than an upper limit value of the allowable range, and generates a second frequency control signal that reduces the frequency of the read clock when the usage rate of the specified FIFO memory is less than a lower limit value of the allowable range.

8. A method for controlling a FIFO circuit including a memory in which a data signal is written to a bit specified by a write pointer that is generated by using a clock of the data signal and the data signal is read from a bit specified by a read pointer that is generated by using a read clock, the method comprising:
detecting a pointer difference between the write pointer and the read pointer;
generating a frequency control signal that changes a frequency of the read clock when the pointer difference is out of an allowable range determined according to a size of the memory; and
controlling the frequency of the read clock according to the frequency control signal.
